(19) United States
(12) Patent Application Publication
(10) Pub. No.: US 2009/0246077 A1
(43) Pub. Date: Oct. 1, 2009

(54) CONTAINER ASSEMBLY FOR SUBLIMATION

(75) Inventors: Ling LU, Lujhu Hsiang (TW); Kai-Chiang HUANG, Pingjhen City (TW); Kang-Wei HSUEH, Jhonghe City (TW); Ching-Hung CHEN, Taichung (TW); Yu-Sen HOU, Ciaotou Hsiang (TW); Yu-Chin LEE, Taipei (TW)

Correspondence Address: PATENTTM.US, P. O. BOX 82788, PORTLAND, OR, 97282-0788, US

(73) Assignee: UFC CORPORATION, TAIPEI (TW)

(21) Appl. No.: 12/059,890

(22) Filed: Mar. 31, 2008

(51) Int. Cl. G01D 13/12

(52) U.S. Cl. 422/55

(57) ABSTRACT

A container assembly has a raw-material container and a product-collection container, which are heat resistant and pressure resistant and have graduations formed on a sidewall thereof and a joint protruding therefrom. The product-collection container is detachably mounted on the raw-material container and communicates with the raw-material container through the joint. Since the raw-material container has graduations, an amount of raw materials can be consistently added in each batch, therefore, conditions of sublimation such as pressure, temperature or the like do not require adjustment and may just be monitored to ensure maximum yield is attained. Therefore, a sublimation procedure is simple, saves time and decreases product costs. Since, the product-collection container has graduations, an amount of product can be observed easily by the graduations and the product is easily removed without removing impure byproducts. Therefore, purity of the product can be increased.

### BACKGROUND OF THE INVENTION

1. Field of Invention

The present invention relates to a container assembly, and more particularly to a container assembly for sublimation that can be used vertically or horizontally and has graduations to accurately quantify raw materials and collected products.

2. Description of the Related Art

Advancement in the optical electronic industry requires improved quality of electronic elements. The quality of the electronic elements is especially affected by purity of specialty chemicals. Generally, each specialty chemical has a cracking temperature and a melting point that is higher than the cracking temperature. Therefore, a traditional physical purification such as distillation cannot purify the specialty chemical without harming the specialty chemical.

Because the specialty chemical has high melting point, sublimation under high temperature and high vacuum is the best purification method of the specialty chemical.

Sublimation under high temperature and vacuum is widely used to purify materials of organic semiconductors, such as materials for: organic photo-conductors, charge transport layers in laser printers, charge transport layers, hole injection layer (HIL) and fluorescent and phosphorescence emitting layers in organic light emitting displays.

Accordingly, apparatuses for sublimation with high temperature and high vacuum are developed. Sublimation apparatuses are discussed in U.S. Pat. No. 5,377,429, U.S. Pat. No. 4,407,488, U.S. Pat. No. 6,878,183 B2, U.S. Pat. No. 6,583,583 B1, U.S. Pat. No. 5,338,518 A, U.S. Pat. No. 5,131,634, JP Patents No. 10158820, JP Patents No. 200093701, JP Patents No. 2003095992, JP Patents No. 2006272071, CN Patents No. 200420016606.6, CN Patents No. 200410080822.1, TW Patents No. 200611301, TW Patents No. 1242463, TW Patents No. 461347 and TW Patents No. 509097, which are incorporated herein by reference.

The apparatus in the foregoing references comprises a sublimator with a temperature controller and high-vacuum system equipment to increase purity and production. However, the prior art does not disclose improved containers used for holding raw materials or collecting products. Therefore, conventional containers for sublimation have the following shortcomings:

(1) The conventional containers are designed to be used either vertically or horizontally, so their application is limited to one mode of operation. Moreover, the conventional containers are complex and not suited to mass production.

(2) The conventional containers have no graduations to quantify raw materials or a purified product. Thus, the conventional containers are inconvenient for operators.

(3) Since conventional containers for holding raw materials have no graduations, quantities of raw materials therein are not easily measurable, and are not equal between batches. Therefore, temperature, pressure or other conditions of the sublimator have to be adjusted for such changes in quantity and much operator time is wasted, increasing production costs.

(4) Having no graduations means the product cannot be easily quantified so production yield is difficult to calculate and may cause errors and wastage of raw materials.

(5) Operators cannot distinguish an interface between pure product from impure byproduct. Therefore, when pure product is removed from the conventional container, impure byproduct may be removed therewith, causing errors in purity or contamination of the entire sample.

To overcome the shortcomings, the present invention provides a container assembly for sublimation to mitigate or obviate the aforementioned.

### SUMMARY OF THE INVENTION

The primary objective of the present invention is to provide a container assembly for sublimation, which can be used vertically or horizontally and has graduations to accurately quantify raw materials and collected products.

To achieve the objective, the container assembly for sublimation in accordance with the present invention has a raw-material container and a product-collection container. The raw-material container is heat resistant and pressure resistant and has a sidewall, graduations and a joint. The graduations are formed on the sidewall of the raw-material container. The joint is formed on and protrudes from the raw-material container. The product-collection container is mounted detachably on the raw-material container, communicates with the raw-material container, is heat resistant pressure resistant and has a sidewall, graduations and a joint. The graduations are formed on a sidewall of the product-collection container. The joint is formed on and protrudes from the product-collection container and is detachably mounted on the joint of the raw-material container. Since the raw-material container has graduations, an amount of raw materials can be consistently added in each batch, therefore, conditions of sublimation such as pressure, temperature or the like do not require adjustment and may just be monitored to ensure maximum yield is attained. Therefore, a sublimation procedure is simple, saves time and decreases product costs. Since, the product-collection container has graduations, an amount of product can be observed easily by the graduations and the product is easily removed without removing impure byproducts. Therefore, purity of the product can be increased.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a container assembly for sublimation in accordance with the present invention;

FIG. 2 is a perspective view of the container assembly for sublimation in FIG. 1;

FIG. 3 is a side view of the container assembly for sublimation in FIG. 1, used horizontally in a first mode of operation;

FIG. 4 is a side view of the container assembly for sublimation in FIG. 1, used vertically, in a second mode of operation

FIG. 5 is an HPLC chromatogram of a product in a first example of the present invention; and

FIG. 6 is a fluorescence spectrum of the product in FIG. 5.

### DETAILED DESCRIPTION OF THE INVENTION

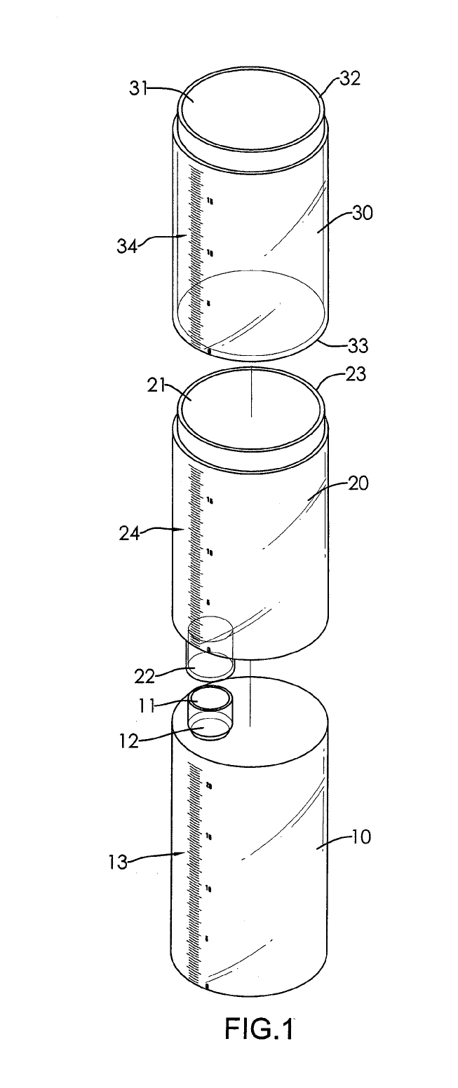

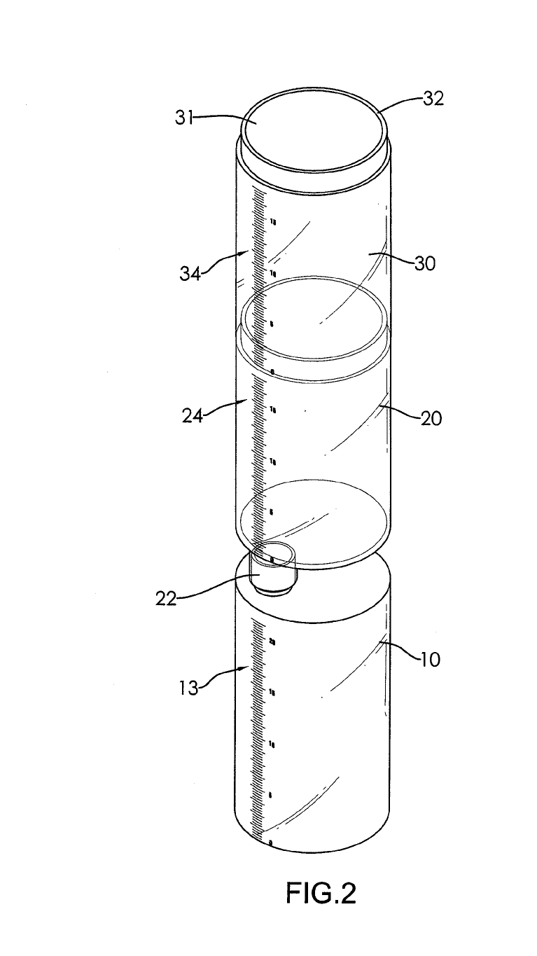

With reference to FIGS. 1 and 2, a container assembly in accordance with the present invention has a raw-material container (10), a product-collection container (20) and at least one extension container (30).

The raw-material container (10) is heat resistant and pressure resistant, is resistant to high temperature and low pressure, may be cylindrical, may be glass and has an inner chamber (11), a proximal end, a distal end, a sidewall, a first joint (12) and graduations (13). The raw-material container (10) can endure an instant temperature change between 160° C.˜180° C. and endures temperatures between 490° C.˜510° C. without deformation or cracking. The material container (10) endures pressures between 0.1×10⁻⁶˜1×10⁻⁶ mbar. Preferably the glass is borosilicate glass and does not contain magnesium oxide, calcium carbonate and heavy metals. The inner chamber (11) holds raw materials. The first joint (12) is formed on and protrudes from the distal end of the raw-material container (10), communicates with the inner chamber (11) and may protrude eccentrically from the distal end of the raw-material container (10). The graduations (13) are formed on the sidewall of the raw-material container (10) to quantify raw materials placed therein. The graduations (13) may demarcate at intervals of 2 mm from 0 mm to 150 mm.

The product-collection container (20) is detachably mounted on the raw-material container (10), is heat resistant and pressure resistant, is resistant to high temperature and pressure, may be cylindrical, may be glass and has an inner chamber (21), a proximal end, a distal end, a sidewall, a second joint (22), a distal opening (23) and graduations (24). The product-collection container (20) endures an instant temperature change between 160˜180° C. and endures temperatures between 490˜510° C. without deformation or cracking. The product-collection container (20) endures pressures between 0.1×10⁻⁶ ˜1×10⁻⁶ mbar. Preferably the glass is borosilicate glass and does not contain magnesium oxide, calcium carbonate and heavy metals. The inner chamber (21) of the product-collection container (20) communicates with the inner chamber (11) of the raw-material container (10). The proximal end of the product-collection container (20) is mounted adjacent to the distal end of the raw-material container (10). The second joint (22) is formed on and protrudes from the proximal end of the product-collection container (20), communicates with the inner chamber (21) and detachably engages the first joint (12) of the product-collection container (20). The second joint (22) may protrude eccentrically from the proximal end of the product-collection container (20). The distal opening (23) is formed in the distal end of the product-collection container (20), communicates with the inner chamber (21) of the product-collection container (20) and has an annular shoulder to allow attachments thereon. The graduations (24) of the product-collection container (20) are formed on the sidewall of the product-collection container (20) to quantify products therein. The graduations (24) of the product-collection container (20) may demarcate at intervals of 2 mm from 0 mm to 120 mm.

Each extension container (30) is heat resistant and pressure resistant, is resistant to high temperature and low pressure, may be cylindrical, may be made of glass and has an inner chamber (31), a proximal end, a distal end, a sidewall, an extension distal opening (32), a proximal opening (33) and graduations (34). The extension container (30) endures an instant temperature change between 160 ˜180° C. and endures temperatures between 490˜510° C. without deformation or cracking. The extension container (30) endures pressures between 0.1×10⁻⁶ ˜1×10⁻⁶ mbar. Preferably the glass is borosilicate glass and does not contain magnesium oxide, calcium carbonate and heavy metals.

The inner chamber (31) of the extension container (30) communicates with the inner chamber (21) of the product-collection container (20) and the inner chamber (11) of the raw-material container (10) and may further communicate with the inner chamber of other extension containers (30) attached thereto.

The proximal end of one extension container (30) is mounted adjacent to the distal opening (23, 32) of an adjacent container (10, 30).

The extension distal opening (32) is formed in the distal end of the extension container (30), communicates with the inner chamber (31) of the extension container (30) and has an annular shoulder to allow attachments thereon.

The proximal opening (33) of the extension container (30) is formed in the proximal end of the extension container (30) and is detachably mounted on the distal opening (21, 32) of the adjacent container (20, 30). The graduations (34) of the extension container (30) are formed on the sidewall of the extension container (30) to quantify products therein. The graduations (34) of the extension container (30) may demarcate at intervals of 2 mm from 0 mm to 120 mm.

When the container assembly of the present invention is used, the raw materials are added to the raw-material container (10) and an amount of the raw materials is know by the graduations (13). Then, the second joint (22) of the product-collection container (20) is mounted securely on the first joint (12) of the raw-material container (10). An amount of product can be evaluated according to an amount of the raw materials. Therefore, the proximal opening (33) of the extension container (30) may be mounted on the distal opening (23) of the product-collection container (20) extension in series to allow room for products therein. After the raw materials are sublimed and the product desublimes on the product-collection container (20), the extension container (30) or both, the amount of product can be determined according to the graduations (24, 34) of the product-collection container (20) and the extension container (30). Then, the product can be removed from the product-collection container (20) and the extension container (30) and purity of the product can be measured.

Because the raw-material container (10) has graduations (13), the amount of the raw materials can be equal in each batch, so conditions of sublimation such as pressure, temperature or the like do not require adjustment and can be adjusted only to gain improved yield. Therefore, a sublimation procedure is simple, saves time and decreases product costs. Moreover, the product-collection container (20) and the extension container (30) have graduations (24, 34). Therefore, an amount of product can be observed easily by the graduations (24, 34) and the product is easily removed without removing impure byproducts. Therefore, the purity of the product can be increased.

Furthermore, the container assembly can be set either horizontally or vertically, so it is very convenient for operators and can be applied in various industries.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

### EXAMPLE

The following examples illustrate and exemplify the present invention. Therefore, these examples should not be considered as limitations of the present invention, but merely teach those skilled in the art how to use the container assembly of the present invention.

In the following examples, the raw-material container, product-collection container and extension container were weighed separately then the raw-material container was filled with raw materials and weighed before proceeding with sublimation. A weight of the raw materials can be obtained by subtracting a weight of the raw-material container before being filled with raw materials from a weight of the raw-material container after being filled with raw materials. After sublimation, the product-collection container and the extension container were weighed to gain a product yield. Also, the graduations of the product-collection container and the extension container were observed before and the product was removed from the product-collection container and the extension container using a scraper.

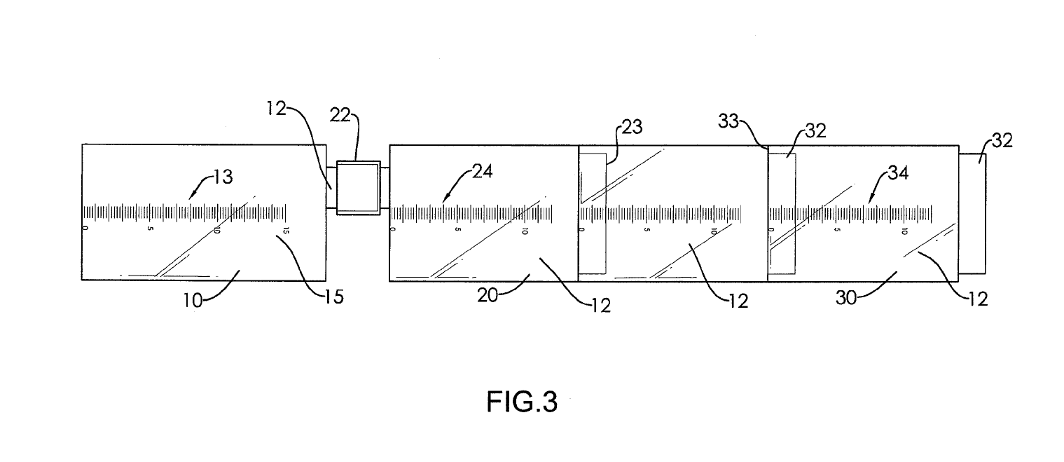

With reference to FIG. 3, the container assemblies in following examples 1 to 6 were set horizontally.

### Example 1

### Procedure

500 grams of Zirconium tetra(8-Hydroxyquinoline) (ZrQ₄, wherein Q represents 8-Hydroxyquinoline) containing inorganic compound or other impurities was added to the raw-material container (10, graduation (13) interval of 2 mm and from 0 cm to 15 cm) from 0 cm to 15 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 360° C. under 0.3×10⁻⁶ mbar. The product-collection container (20) and the extension containers (30) were cooled to about 280° C. After about 5 hours, sublimation and desublimation were complete. Product (pure ZrQ₄) was attached to the sidewalls of the product-collection container (20) and the extension containers (30).

Result

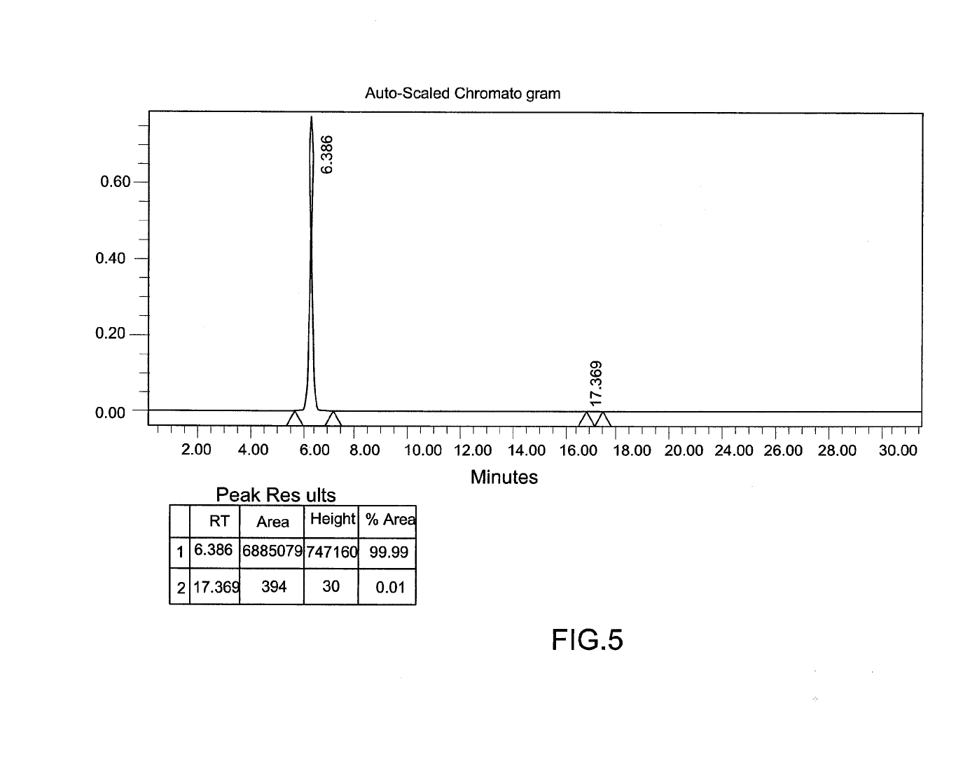

With further reference to FIG. 5, the product was attached to the product-collection container (20) from 0 cm to 12 cm and to an adjacent extension container (30) from 0 cm to 4 cm. Total weight of the product was 405 gram. Product yield was 81%. Purity of the product was 99.9% that was analyzed by high performance liquid chromatography (HPLC), wherein analysis conditions of HPLC are shown in table 1.

TABLE 1
ANALYSIS CONDITIONS OF HPLC

| | |
|---|---|
| Equipment | Waters 2996 PDA & 2695 Module |
| Column | Nucleosil CN 5 μm 250 mm × 4.6 mm |
| Flow Rate | 0.5 ml/min |
| Mobile Phase | 100% THF |
| Detector | UV at 254 nm |
| Solvent | 100% THF |
| Inject volumes | 10 μl |
| Sample Conc. | 5 mg/100 ml solvent |
| Column Temp. | 30° C. |

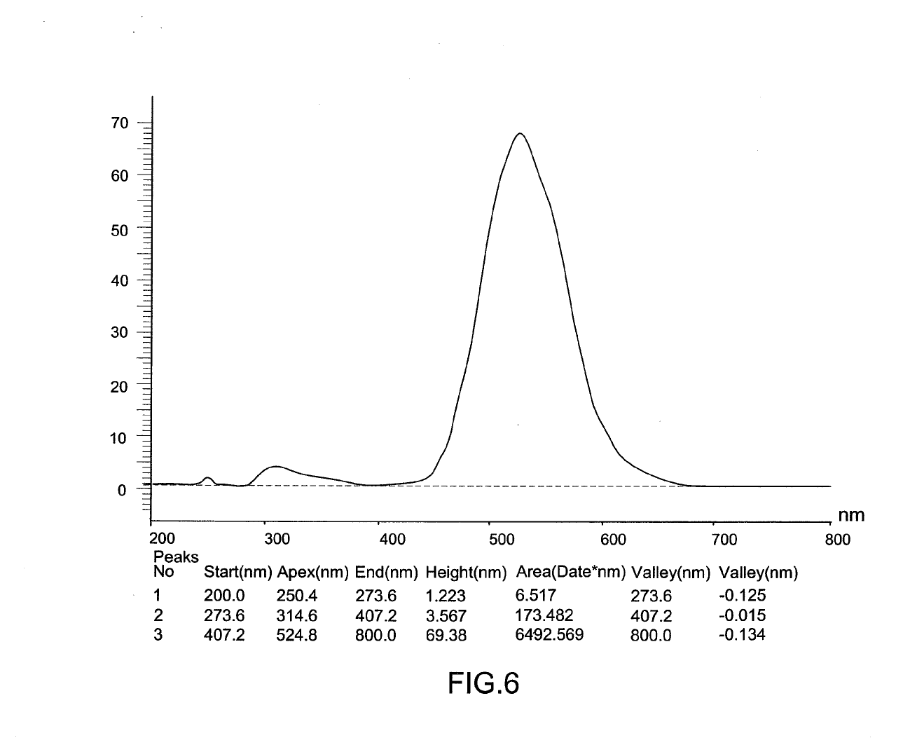

The product was further qualitatively analyzed by fluorescence spectra (HITACHI F-7000 FL, JAPAN). 500 mg of product (pure ZrQ₄) were dissolved in 100 ml of acetonitrile (ACN) to form a solution and then 1 ml of the solution was diluted 100 times with ACN to obtain a sample. Then the sample was analyzed by the fluorescence spectra. FIG. 6 is a fluorescence spectrum of the sample and proved the product is ZrQ₄.

### Example 2

### Procedure

250 grams of ZrQ₄ containing inorganic compound or other impurities were added into the raw-material container (10, graduation (13) interval of 2 mm and from 0 cm to 15 cm) from 0 cm to 7 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 360° C. under 0.3×10⁻⁶ mbar. The product-collection container (20) and the extension containers (30) were cooled to about 280° C. After about 3 hours, sublimation and desublimation were complete. Product (pure ZrQ₄) was attached to the sidewalls of the product-collection container (20) and the extension containers (30).

Result

The analysis method was the same as Example 1. The product was attached to the product-collection container (20) from 0 cm to 8 cm. Total weight of the product was 200 gram. Product yield was 80%. Purity of the product was 99.6% as analyzed by HPLC.

### Example 3

### Procedure

495 gram of N,N-bisphenyl-N,N-bis(1-naphthyl)-benzidine (NPB) containing inorganic compound or other impurities was added to the raw-material container (10, graduation (13) interval of 2 mm and from 0 cm to 15 cm) from 0 cm to 15 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 330° C. under 0.3×10⁻⁶ mbar. The product-collection container (20) and the extension containers (30) were cooled to about 200° C. After about 4.5 hours, sublimation and desublimation were complete. Product (pure NPB) was attached to the sidewalls of the product-collection container (20) and the extension containers (30).

Result

The product was attached to the product-collection container (20) from 0 cm to 12 cm and to an adjacent extension container (30) from 0 cm to 5 cm. Total weight of the product was 396 grams. Product yield was 80%. Purity of the product was 99.6% as analyzed by HPLC, wherein analysis conditions of HPLC are shown in table 2, wherein CAN is acetonitrile and THF is tetrahydrofuran.

TABLE 2
ANALYSIS CONDITIONS OF HPLC

| | |
|---|---|
| Equipment | Waters 2996 PDA & 2695 Module |
| Column | Phenomenex Luna C18(2) 5 μm 250 mm × 4.6 mm |
| Flow Rate | 1.0 ml/min |
| Mobile Phase | ACN:THF = 90:10 |
| Detector | UV at 340 nm |
| Solvent | 100% THF |
| Inject volumes | 10 μl |
| Sample Conc. | 20 mg/100 ml solvent |
| Column Temp. | 30° C. |

### Example 4

### Procedure

250 grams of NPB containing inorganic compound or other impurities were added to the raw-material container (10, graduation (13) interval of 2 mm and from 0 cm to 15 cm) from 0 cm to 7.6 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 330° C. under 0.3×10⁻⁶ mbar. The product-collection container (20) and the extension containers (30) were cooled to about 200° C. After about 3 hours, sublimation and desublimation were complete. Product (pure NPB) was attached to the sidewalls of the product-collection container (20) and the extension containers (30).

Result

The analysis method is the same as Example 3. The product was attach to the product-collection container (20) from 0 cm to 9 cm. Total weight of the product was 212.6 gram. Product yield was 85%. Purity of the product was 99.7% as analyzed by HPLC.

### Example 5

### Procedure

495 grams of Aluminum tri-(8-Hydroxyquinoline) (AlQ₃, wherein Q represents 8-Hydroxyquinoline) containing inorganic compound or other impurities was added into the raw-material container (10, graduation (13) interval of 2 mm and from 0 cm to 15 cm) from 0 cm to 15 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 350° C. under 0.3×10⁻⁶ mbar. The product-collection container (20) and the extension containers (30) were cooled to about 160° C. After about 4 hours, sublimation and reverse sublimation were completed. Product (pure AlQ₃) was attached to the sidewalls of the product-collection container (20) and the extension containers (30).

Result

The product was attached to the product-collection container (20) from 0 cm to 12 cm and to an adjacent extension container (30) from 0 cm to 6 cm. Total weight of the product was 425.7 gram. Product yield was 86%. Purity of the product was 99.5% as analyzed by high performance liquid chromatography (HPLC), wherein analysis conditions of HPLC are shown in table 3.

TABLE 3
ANALYSIS CONDITIONS OF HPLC

| | |
|---|---|
| Equipment | Waters 2996 PDA & 2695 Module |
| Column | Phenomenex Luna C18(2) 5 μm 250 mm × 4.6 mm |
| Flow Rate | 1.0 ml/min |
| Mobile Phase | ACN:H₂O = 60:40 |
| Detector | UV at 254 nm |
| Solvent | 100% ACN |
| Inject volumes | 10 μl |
| Sample Conc. | 10 mg/100 ml Solvent |
| Column Temp. | 30° C. |

NOTE:
Sample is dissolved in ACN and is vibrated for 10 to 15 min.

### Example 6

### Procedure

250 grams of AlQ₃ containing inorganic compound or other impurities was added to the raw-material container (10, graduation (13) interval of 2 mm and from 0 cm to 15 cm) from 0 cm to 7.6 cm of graduations. The raw-material container (10) was horizontally connected with one product-collection container (20, graduation (24) interval of 2 mm and from 0 cm to 12 mm) and two extension containers (30, graduation (34) interval of 2 mm and from 0 cm to 12 mm). Then, sublimation was performed under the following conditions. The raw-material container (10) was heated to about 350° C. under 0.3×10⁻⁶ mbar. The product-collection container (20) and the extension containers (30) were cooled to about 160° C. After about 3 hours, sublimation and desublimation were complete. Product (pure AlQ₃) was attached to the sidewalls of the product-collection container (20) and the extension containers (30).

Result

The analysis method was the same as Example 5. The product was attached to the product-collection container (20) from 0 cm to 10 cm. Total weight of the product was 225 grams. Product yield was 90%. Purity of the product was 99.6% as was analyzed by HPLC.

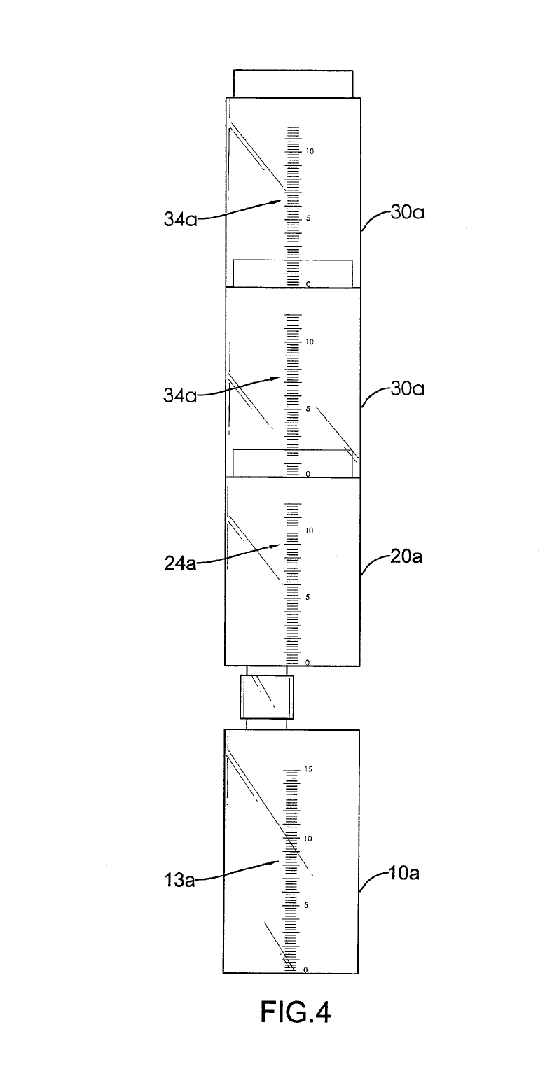

With reference to FIG. 4, the container assemblies in following examples 7 and 8 were set vertically.

### Example 7

### Procedure

500 grams of ZrQ₄ containing inorganic compound or other impurities was added to the raw-material container (10a, graduation (13a) interval of 2 mm and from 0 cm to 15 cm) from 0 cm to 15 cm of graduations. The raw-material container (10a) was vertically connected with one product-collection container (20a, graduation (24a) interval of 2 mm and from 0 cm to 12 mm) and two extension containers (30a, graduation (34a) interval of 2 mm and from 0 cm to 12 mm). Then, sublimation was performed under the following conditions. The raw-material container (10a) was heated to about 360° C. under 0.3×10⁻⁶ mbar. The product-collection container (20a) and the extension containers (30a) were cooled to about 280° C. After about 6 hours, sublimation and desublimation were complete. Product (pure ZrQ₄) was attached to the sidewalls of the product-collection container (20a) and the extension containers (30a).

Result

The analysis method is the same as Example 1. the product was attached to the product-collection container (20a) from 0 cm to 12 cm and to an adjacent extension container (30a) from 0 cm to 2 cm. Total weight of the product was 400.2 grams. Product yield was 80%. Purity of the product was 99.4% as was analyzed by HPLC.

### Example 8

### Procedure

250 grams of ZrQ₄ containing inorganic compound or other impurities was added to the raw-material container (10a, graduation (13a) interval of 2 mm and from 0 cm to 15 cm) from 0 cm to 7 cm of graduations. The raw-material container (10a) was vertically connected with one product-collection container (20a, graduation (24a) interval of 2 mm and from 0 cm to 12 mm) and two extension containers (30a, graduation (34a) interval of 2 mm and from 0 cm to 12 mm). Then, sublimation was performed under the following conditions. The raw-material container (10a) was heated to about 360° C. under 0.3×10⁻⁶ mbar. The product-collection container (20a) and the extension containers (30a) were cooled to about 280° C. After about 4 hours, sublimation and desublimation were completed. Product (pure ZrQ₄) was attached to the sidewalls of the product-collection container (20a) and the extension containers (30a).

Result

The analysis method and conditions are the same as Example 1. The product was attached to the product-collection container (20a) from 0 cm to 6 cm. Total weight of the product was 195 grams. Product yield was 78%. Purity of the product was 99.5% as was analyzed by HPLC.

According to the above examples, the containers of the present invention have graduations, so the operators easily distinguish pure product from impure byproduct. Thus, the operators conveniently scrape the pure product from the product-collection container and extension containers and also rapidly evaluate the product. Furthermore, the purity of the product is improved no matter if the container assembly is set horizontally or vertically since the correct portions can be removed. The container assembly can be reused after being cleaned.

What is claimed is:

1. A container assembly comprising:
a raw-material container being heat resistant and pressure resistant and having
an inner chamber;
a distal end;
a sidewall;
a first joint being formed on and protruding from the distal end of the raw-material container and communicating the inner chamber; and
graduations being formed on the sidewall of the raw-material container; and
a product-collection container being detachably mounted on the raw-material container, being heat resistant and pressure resistant and having
an inner chamber communicating with the inner chamber of the raw-material container;
a proximal end being mounted adjacent to the distal end of the raw-material container;
a distal end;
a sidewall;
a second joint being formed on and protruding from the proximal end of the product-collection container, communicating with the inner chamber and detachably engaging the first joint of the product-collection container;
a distal opening being formed in the distal end of the product-collection container and communicating with the inner chamber of the product-collection container; and
graduations being formed on the sidewall of the product-collection container.

2. The container assembly as claimed in claim 1 further comprising at least one extension container and each extension container being heat resistant and pressure resistant and having
an inner chamber communicating with the inner chamber of the product-collection container and the inner chamber of the raw-material container and the inner chamber of other extension containers attached thereto;
a proximal end of one extension container is mounted adjacent to the distal opening of an adjacent container;
a distal end;
a sidewall;
an extension distal opening being formed in the distal end of the extension container and communicating with the inner chamber of the extension container;
a proximal opening being formed in the proximal end of the extension container and being detachably mounted on the distal opening of the adjacent container; and
graduations being formed on the sidewall of the extension container.

3. The container assembly as claimed in claim 1, wherein the raw-material container and the product-collection container are made of glass.

4. The container assembly as claimed in claim 2, wherein the raw-material container, the product-collection container and each extension container are made of glass.

5. The container assembly as claimed in claim 1, wherein the raw-material container and the product-collection container are made of borosilicate glass.

6. The container assembly as claimed in claim 2, wherein the raw-material container, the product-collection container and each extension container are made of borosilicate glass.

7. The container assembly as claimed in claim 1, wherein
the raw-material container and the product-collection container endure an instant temperature change between 160° C.˜180° C.

8. The container assembly as claimed in claim 2, wherein
the raw-material container, the product-collection container and each extension container endure an instant temperature change between 160° C.˜180° C.

9. The container assembly as claimed in claim 7, wherein
the raw-material and
the product-collection container endure temperatures between 490° C.˜510° C.

10. The container assembly as claimed in claim 8, wherein
the raw-material container, the product-collection container and each extension container endure temperatures between 490° C. 510° C.

11. The container assembly as claimed in claim 7, wherein
the raw-material container and
the product-collection container endure pressures between 0.1×10⁻⁶˜1×10⁻⁶ mbar.

12. The container assembly as claimed in claim 8, wherein
the raw-material container, the product-collection container and
each extension container endure pressures between 0.1×10⁻⁶˜10⁻⁶ mbar.

13. The container assembly as claimed in claim 9, wherein
the raw-material container and
the product-collection container endure pressures between 0.1×10⁻⁶˜1×10⁻⁶ mbar.

14. The container assembly as claimed in claim 10, wherein
the raw-material container;
the product-collection container; and
each extension container endure pressures between 0.1×10⁻⁻⁶˜1×10⁻⁶ mbar.

15. The container assembly as claimed in claim 1, wherein
the raw-material container and
the product-collection container are cylindrical.

16. The container assembly as claimed in claim 2, wherein
the raw-material container;
the product-collection container; and
each extension container are cylindrical.

17. The container assembly as claimed in claim 15, wherein
the first joint of the raw-material container protrudes eccentrically from the distal end of the raw-material container; and
the second joint of the product-collection container protrudes eccentrically from the proximal end of the product-collection container.

18. The container assembly as claimed in claim 16, wherein
the first joint of the raw-material container protrudes eccentrically from the distal end of the raw-material container; and
the second joint of the product-collection container protrudes eccentrically from the proximal end of the product-collection container.
